(19) United States
(12) Patent Application Publication
(10) Pub. No.: US 2025/0086483 A1
(43) Pub. Date: Mar. 13, 2025

(54) EDGE-MASKING GUIDED NODE PRUNING

(71) Applicant: Rakuten Mobile, Inc., Tokyo (JP)

(72) Inventors: Bailey ECCLES, St. Andrews (GB); Blesson VARGHESE, St. Andrews (GB); Philip RODGERS, London (GB); Peter KILPATRICK, Belfast (GB); Ivor SPENCE, Belfast (GB)

(21) Appl. No.: 18/247,646

(22) PCT Filed: Dec. 21, 2022
(86) PCT No.: PCT/US2022/053590

§ 371 Date: Apr. 3, 2023

Related U.S. Application Data
(60) Provisional application No. 63/386,954, filed on Dec. 12, 2022.

(51) Int. Cl. G06N 5/04

(52) U.S. Cl. CPC G06N 5/04

(57) ABSTRACT

Edge-masking guided node pruning is performed by masking at least one edge among a plurality of edges of a trained model to produce a masked model, initializing the masked model, training the masked model, detecting, from among a plurality of channels of the masked model, each channel among the plurality of channels including a set of edges among the plurality of edges, at least one zero channel in which each edge among the set of edges is masked; determining, from among a plurality of nodes of the masked model, each node corresponding to two channels among the plurality of channels, at least one removable node in which the corresponding two channels are zero channels; and pruning the masked model to remove the removable nodes from the masked model, resulting in a pruned model.

### PRIORITY CLAIM AND CROSS-REFERENCE

This application claims priority to U.S. Provisional Application No. 63/386,954 filed Dec. 12, 2022, which is hereby incorporated by reference in its entirety.

### BACKGROUND

### Technical Field

This description relates to edge-masking guided node pruning.

### Background

Deep neural networks (DNNs) underpin many machine learning applications. High inference accuracy of production quality DNN models is achieved by training millions of DNN parameters that have a significant resource footprint. Therefore, for edge resources, such as mobile and embedded devices that have relatively limited computational resources, models are compressed into lightweight variants.

### SUMMARY

According to at least some embodiments of the subject disclosure, edge-masking guided node pruning is performed by masking at least one edge among a plurality of edges of a trained model to produce a masked model, initializing the masked model, training the masked model, detecting, from among a plurality of channels of the masked model, each channel among the plurality of channels including a set of edges among the plurality of edges, at least one zero channel in which each edge among the set of edges is masked; determining, from among a plurality of nodes of the masked model, each node corresponding to two channels among the plurality of channels, at least one removable node in which the corresponding two channels are zero channels; and pruning the masked model to remove the removable nodes from the masked model, resulting in a pruned model.

Some embodiments include the instructions in a computer program, the method performed by the processor executing the instructions of the computer program, and an apparatus that performs the method. In some embodiments, the apparatus includes a controller including circuitry configured to perform the operations in the instructions.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an operational flow for edge-masking guided node pruning, according to at least some embodiments of the subject disclosure.

FIG. 2 is a schematic diagram of a neural network model, according to at least some embodiments of the subject disclosure.

FIG. 3 is a schematic diagram of a masked neural network model, according to at least some embodiments of the subject disclosure.

FIG. 4 is a schematic diagram of a channel of a kernel of a neural network model, according to at least some embodiments of the subject disclosure.

FIG. 5 is a schematic diagram of a channel of a kernel of a masked neural network model, according to at least some embodiments of the subject disclosure.

FIG. 6 is a schematic diagram of a zero channel of a kernel of a masked neural network model, according to at least some embodiments of the subject disclosure.

FIG. 7 is a schematic diagram of a pruned neural network model, according to at least some embodiments of the subject disclosure.

FIG. 8 is an operational flow for generating and deploying pruned models, according to at least some embodiments of the subject disclosure.

FIG. 9 is an operational flow for composing a pruned model portfolio, according to at least some embodiments of the subject disclosure.

FIG. 10 is a schematic diagram of a model portfolio, according to at least some embodiments of the subject disclosure.

FIG. 11 is a schematic diagram of a system for generating and deploying pruned models, according to at least some embodiments of the subject disclosure.

FIG. 12 is an operational flow for deploying pruned models to a computation device, according to at least some embodiments of the subject disclosure.

FIG. 13 is an operational flow for deploying pruned models to a cloud server, according to at least some embodiments of the subject disclosure.

FIG. 14 is an operational flow for initiating inference with a model portfolio on a computation device, according to at least some embodiments of the subject disclosure.

FIG. 15 is an operational flow for performing inference with a model portfolio on a computation device, according to at least some embodiments of the subject disclosure.

FIG. 16 is a block diagram of a hardware configuration for generating and deploying pruned models, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

Approaches for obtaining model variants encounter difficulties in: (1) rapidly obtaining variants from a large search space, (2) maintaining high accuracy for compressed model variants, and (3) adapting the deployed model variant when operational conditions change. At least some embodiments described herein include DNN model training, compression and run-time adaptation that address the challenges mentioned above. At least some embodiments include a hybrid pruning method that includes techniques of structured and unstructured pruning. At least some embodiments enable obtaining smaller and faster model variants while sacrificing minimal accuracy. At least some embodiments include an efficient pruning pipeline enabling generation of a diverse portfolio of model variants for run-time adaptation across varying hardware profiles and operational conditions. At least some embodiments are capable of generating a deployable portfolio of pruned model variants up to 188× faster than alternative methods, and generating pruned model variants up to 5.7× smaller and having 1.8× and 1.4× faster CPU and GPU inference latencies, respectively. At least some embodiments are capable of adapting to fluctuating runtime conditions through real-time model switching, at as low as 13 ms switching latency, while incurring less memory overheads less than 7 times compared to current approaches.

At least some embodiments enable development of models for more computationally efficient image processing, for example, by performing inference of the most efficient model for achieving a required accuracy. At least some embodiments enable efficient facial recognition, image enhancement, object recognition, medical diagnosis, etc. At least some embodiments enable development of models for more computationally efficient processing of any other data inferred through a deep neural network, a convolutional neural network, etc.

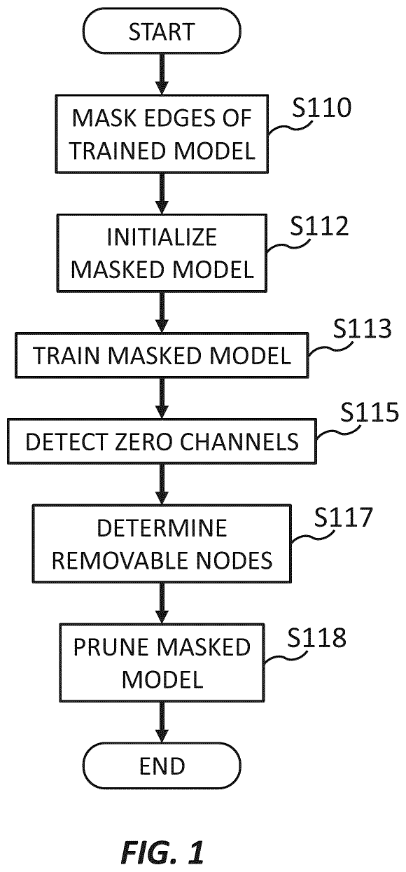

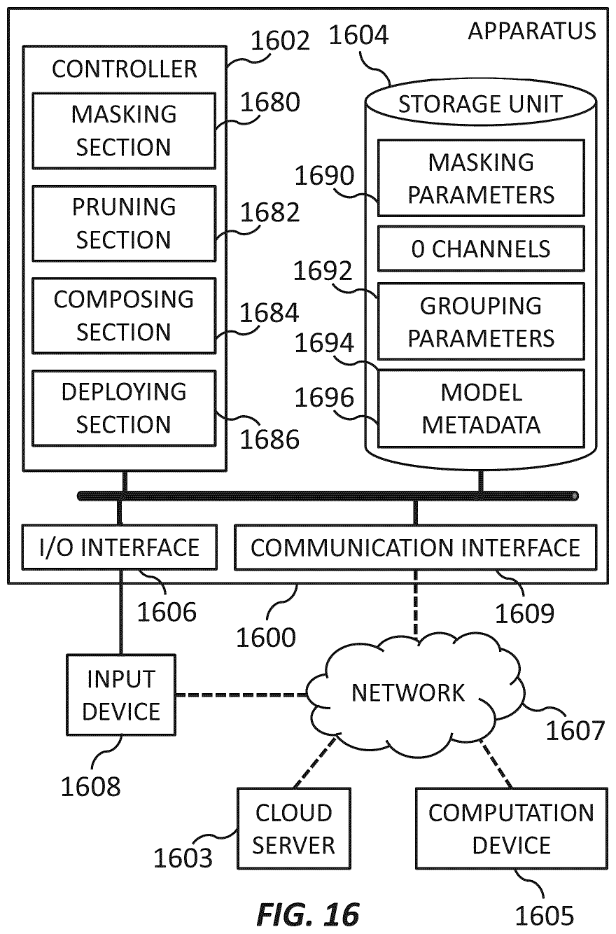

FIG. 1 is an operational flow for edge-masking guided node pruning, according to at least some embodiments of the subject disclosure. The operational flow provides a method of edge-masking guided node pruning. In at least some embodiments, the method is performed by a masking section and a pruning section of an apparatus including sections for performing certain operations, such as the apparatus shown in FIG. 16, which will be explained hereinafter.

At S110, a masking section or a sub-section thereof masks edges of a trained model. In at least some embodiments, the masking section masks at least one edge among a plurality of edges of a trained model to produce a masked model. In at least some embodiments, the masking section masks the trained model by fixing certain edges to a value of zero. In at least some embodiments, the masking section masks edges having a weight value less than a threshold weight value. In at least some embodiments, the masking section uses an unstructured pruning algorithm. In at least some embodiments, the masking section implements a Lottery Ticket Hypothesis (LTH) framework to determine which edges to mask.

At S112, the masking section or a sub-section thereof initializes the masked model. In at least some embodiments, the masking section resets the weight values of the edges of the masked model to random values, except for the masked edges, which remain fixed at zero. In at least some embodiments, the masking section resets biases of nodes of the masked model, and any other trained parameters to random values in addition to the weight values of the unmasked edges. In at least some embodiments, the masking section restores initialized parameters of an untrained model previously trained to become the trained model. In at least some embodiments, the masking section resets the weight values of the edges of the masked model to previously initialized values before the training of the trained model.

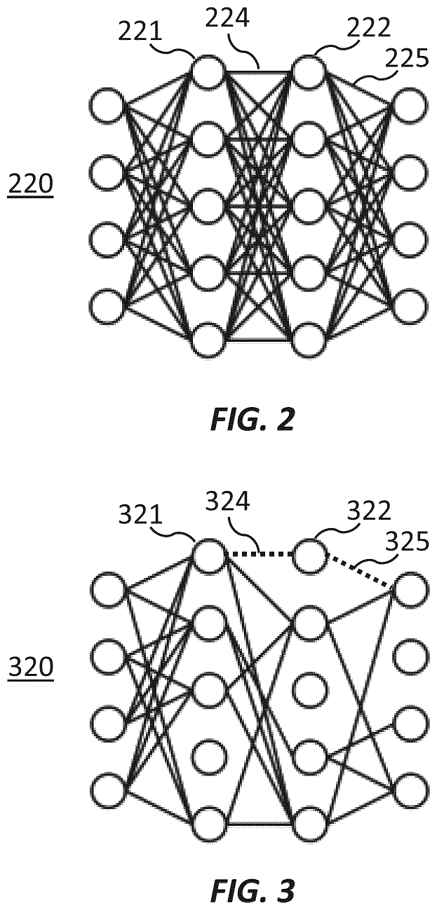

FIG. 2 is a schematic diagram of a neural network model 220, according to at least some embodiments of the subject disclosure. Neural network model 220 includes a plurality of nodes, including nodes 221 and 222, and a plurality of edges 224 and 225. Neural network model 220 is full and unmasked, meaning that all of the edges have trained weight values. For simplicity, neural network 220 only shows a few nodes and edges, but may be much more complex. In at least some embodiments, neural network model 220 is a feed forward neural network, a deep neural network, a convolutional neural network, or any other type of neural network. In at least some embodiments, neural network model 220 has multiple types of layers, including convolution layers, pooling layers, batch normalization layers, fully connected layers, etc. In at least some embodiments, neural network model 220 includes multiple channels of convolution layers.

FIG. 3 is a schematic diagram of a masked neural network model 320, according to at least some embodiments of the subject disclosure. Masked neural network model 320 includes a plurality of nodes, including nodes 321 and 322, and a plurality of edges. Masked neural network model 320 is substantially similar to neural network model 220 of FIG. 2 in structure and function, except where described differently as follows. Masked neural network model 320 includes masked edges, such as masked edges 324 and 325. In at least some embodiments, masked edges 324 and 325 have been fixed at zero, and will remain at zero even during further training. Although node 322 has no incoming or outgoing unmasked edges, node 322 remains a part of masked neural network model 320 because the masking does not change the structure of masked neural network model 320.

At S113, the masking section or a sub-section thereof trains the masked model. In at least some embodiments, the masking section applies the masked model to a training data set, compares the masked model output to expected output, and adjusts the weight values of the unmasked edges based on the comparison to increase an accuracy of the masked model. In at least some embodiments, the masking section trains the masked model until the accuracy is acceptable, until the loss has converged, or for a predetermined number of rounds.

At S115, a pruning section or a sub-section thereof detects zero channels. In at least some embodiments, the pruning section detects, from among a plurality of channels of the masked model, each channel among the plurality of channels including a set of edges among the plurality of edges, at least one zero channel in which each edge among the set of edges is masked. In at least some embodiments, the pruning section searches through each channel of each kernel to determine whether all of the edges in the channel have been masked during the masking at S110. In at least some embodiments, the input data is not divided among multiple channels, and therefore each kernel only has one channel. In at least some embodiments, the pruning section indexes all zero channels for further planning.

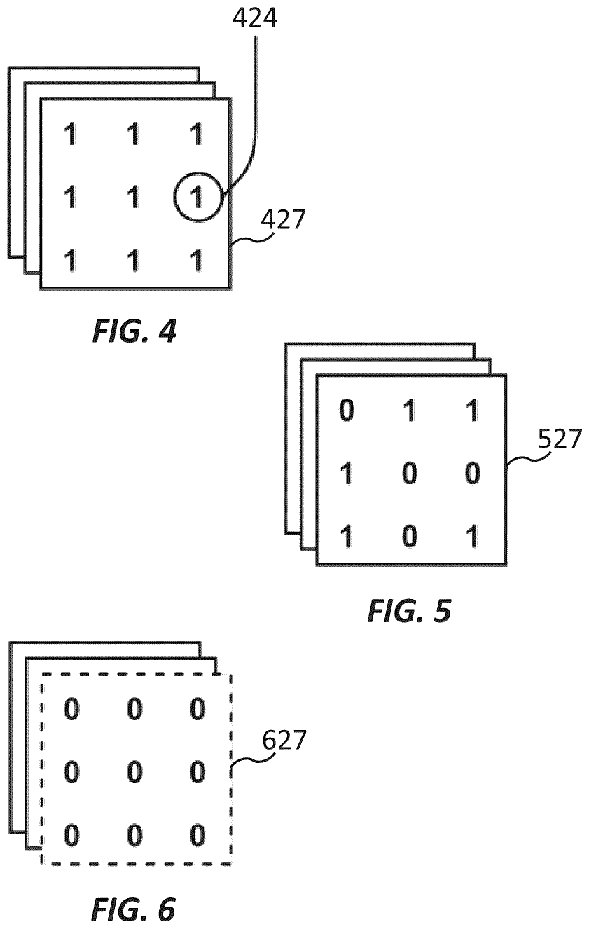

FIG. 4 is a schematic diagram of a channel 427 of a kernel of a neural network model, according to at least some embodiments of the subject disclosure. Channel 427 is composed of a plurality of edges, such as edge 424. The plurality of edges of channel 427 are not exclusive to channel 427, each edge of channel 427 also composing other channels. Channel 427 has a kernel size of 3×3, which means there are nine edges. In at least some embodiments, channels have different kernel sizes, such as 5×5, 7×7, 9×9, etc. The plurality of edges of channel 427 are represented by values of 1, which means the edges of channel 427 are not masked.

FIG. 5 is a schematic diagram of a channel 527 of a kernel of a masked neural network model, according to at least some embodiments of the subject disclosure. Channel 527 is substantially similar to channel 427 of FIG. 4 in structure and function, except where described differently as follows. The plurality of edges of channel 527 are represented by values of 0 and 1, which means that some, but not all, of the edges of channel 527 are masked.

FIG. 6 is a schematic diagram of a zero channel 627 of a kernel of a masked neural network model, according to at least some embodiments of the subject disclosure. Channel 627 is substantially similar to channel 427 of FIG. 4 in structure and function, except where described differently as follows. The plurality of edges of zero channel 627 are represented by values of 0, which means that all of the edges of zero channel 627 are masked. Unlike channel 527 of FIG. 5, which is only partially masked, zero channel 627 can be removed from the neural network model because all of the edges of zero channel 627 are fixed to a value of zero.

In some techniques, channels are removed from a model one at a time. However, removing channels may be computationally intensive since entire convolutional layers comprising multi-dimensional parameter arrays are rebuilt when channels are removed. Furthermore, each channel has dependencies with the channel of the next layer, which are also rebuilt. To reduce such overhead, at least some embodiments break the dependency by first detecting zero channels, such as the detecting at S115, and removing all removable channels and removable nodes at the same time. At least some embodiments achieve this by developing a data structure of prunable channel indices that can be parallelized.

At S117, the pruning section or a sub-section thereof determines removable nodes. In at least some embodiments, the pruning section determines, from among a plurality of nodes of the masked model, each node corresponding to two channels among the plurality of channels, at least one removable node in which the corresponding two channels are zero channels. In at least some embodiments, the pruning section maps each zero channel in an index of all zero channels to a convolutional layer Lₙ where 0≤n<D_{conv}, where D_{conv} model is the convolutional layer depth. In the model of at least some embodiments, each convolutional layer receives two sets of zero channels. The first set, Cᵢₙ is the set of zero out channels from the previous convolutional layer Lₙ₋₁, which correspond to the zero channels of Lₙ. The second set, Cₒᵤₜ is the zero channels of Lₙ. When n=0, indicating the first convolutional layer, there is no Cᵢₙ, and therefore this layer receives an empty set. In at least some embodiments, the pruning section returns a prune plan ((Cᵢₙ,Cₒᵤₜ)) contains all zero channels which are to be pruned for a given convolutional layer. In at least some embodiments, the pruning section determines removable nodes by determining removable zero channels.

At S118, the pruning section or a sub-section thereof prunes the masked model. In at least some embodiments, the pruning section prunes the masked model to remove the removable nodes from the masked model, resulting in a pruned model. In at least some embodiments, the pruning section restructures the neural network model so that the neural network model remains valid without the removed edges and nodes. In at least some embodiments, the pruning section reformats each layer among a plurality of layers of the masked model that includes at least one removable node. In at least some embodiments, the pruning section uses the pruning plan from S117 to prune the masked model. In at least some embodiments, the pruning section executes a pruning plan by rebuilding each convolutional layer without the removable channels and the removable nodes. As all removable nodes and removable channels are determined at S117, in at least some embodiments the pruning section prunes all removable in and out channels in a single batch operation. In at least some embodiments, the pruning section reduces computational overhead and enables real-time pruning by removing all channels and nodes in a single batch operation. In at least some embodiments, the pruning section executes pruning in parallel to concurrently prune each convolutional layer, thereby forming a series of pruned layers L′ that replaces the original unpruned layers L of the masked model. In at least some embodiments, the pruning section creates a pruned layer L′n is created with the smaller channel size |C′ᵢₙ| and |C′ₒᵤₜ|. In at least some embodiments, the pruning section then transfers the pruned set of remaining channels and nodes from Lₙ to L′ₙ.

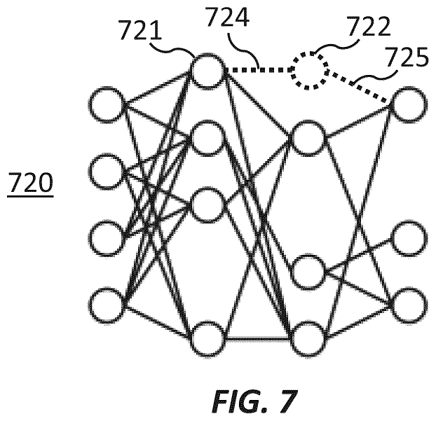

FIG. 7 is a schematic diagram of a pruned neural network model 720, according to at least some embodiments of the subject disclosure. Pruned neural network model 720 includes a plurality of nodes, including node 721, and a plurality of edges. Pruned neural network model 720 is substantially similar to masked neural network model 320 of FIG. 3 in structure and function, except where described differently as follows. Pruned neural network model 720 includes removed edges, such as removed edges 724 and 725, and removed nodes, such as removed node 722. In at least some embodiments, pruned neural network model 720 has been restructured to remove removed edges 724 and 725, such that removed edges are not simply fixed at zero as in masked neural network model 320 of FIG. 3, which requires memory capacity, but removed from the model altogether, reducing the memory capacity requirement. Because node 722 has no incoming or outgoing unmasked edges, node 722 is also removed from pruned neural network model 720 because the pruning changes the structure of a neural network model.

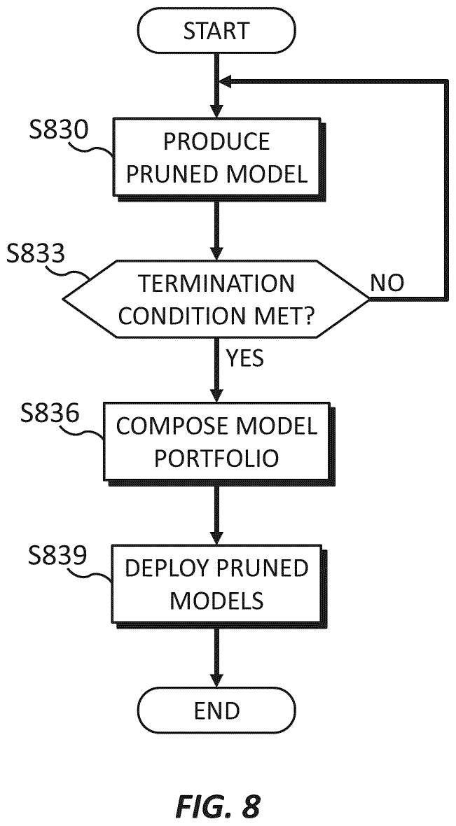

FIG. 8 is an operational flow for generating and deploying pruned models, according to at least some embodiments of the subject disclosure. The operational flow provides a method of generating and deploying pruned models. In at least some embodiments, the method is performed by a controller of an apparatus including sections for performing certain operations, such as the controller and apparatus shown in FIG. 16, which will be explained hereinafter.

At S830, a masking section and a pruning section produce pruned models. In at least some embodiments, the masking section produces a plurality of masked models by performing iterations of the masking, the initializing, and the training. In at least some embodiments, the masking section and the pruning section perform the operations of FIG. 1. In at least some embodiments, the masking section uses the trained model of each subsequent iteration as the masked model after the training of a preceding iteration. In at least some embodiments, the pruning section performs the detecting, determining, and restructuring for each masked model among the plurality of masked models, resulting in a plurality of pruned models.

At S833, the controller or a section thereof determines whether a termination condition has been met. In at least some embodiments, the termination condition is met after a predetermined number of pruned models have been produced. In at least some embodiments, the termination condition is met when a time limit is exceeded. In at least some embodiments, each iteration includes testing an accuracy of the masked model, and determining a decrease in accuracy between the accuracy of the masked model and a preceding accuracy of a preceding masked model of a preceding iteration, and in at least some such embodiments, the termination condition is met when the decrease in accuracy exceeds a threshold accuracy change value. If the controller determines that the termination condition has not been met, then the operational flow returns to pruned model production at S830. In at least some embodiments, each subsequent iteration of S830 further comprises increasing the threshold weight value used to mask edges during an edge masking operation, such as the operation at S110 of FIG. 1. If the controller determines that the termination condition has been met, then the operational flow proceeds to model portfolio composition at S836.

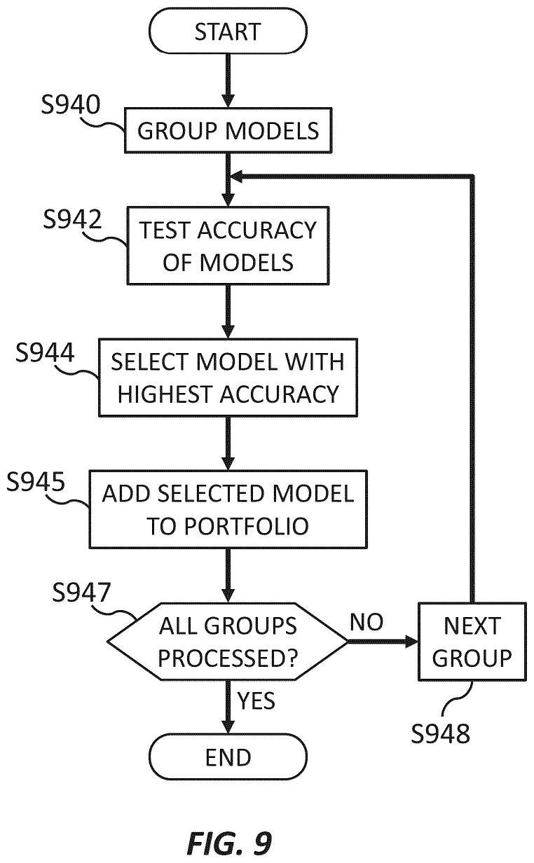

At S836, a composing section composes a model portfolio. In at least some embodiments, the composing section selects pruned models that have a higher accuracy-to-size ratio from among the plurality of pruned models produced at S830 to include the model portfolio. In at least some embodiments, the composing section performs the operations of FIG. 9, explained hereinafter.

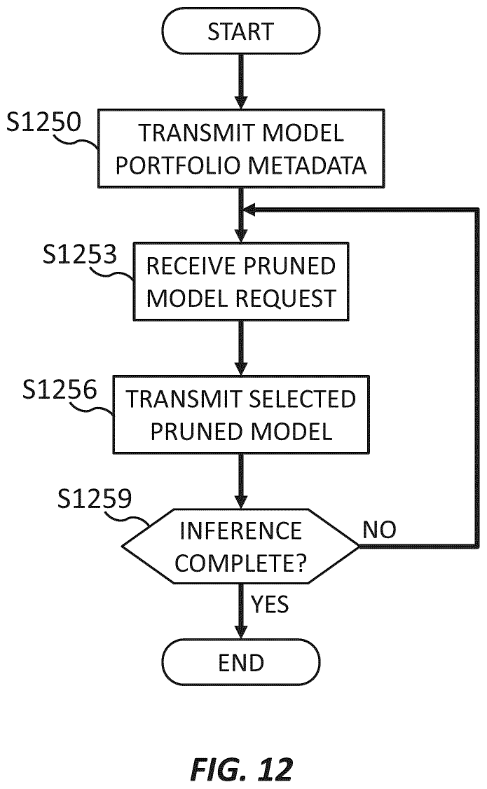

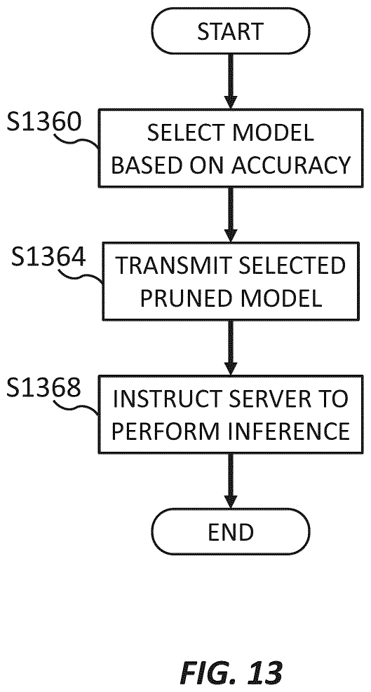

At S839, a deploying section deploys pruned models. In at least some embodiments, the deploying section deploys pruned models of the model portfolio composed at S836. In at least some embodiments, the deploying section deploys the pruned models for performance of inference by computations devices, cloud servers, or both. In at least some embodiments, the deploying section performs the operations of FIG. 12, explained hereinafter. In at least some embodiments, the deploying section performs the operations of FIG. 13, explained hereinafter.

FIG. 9 is an operational flow for composing a pruned model portfolio, according to at least some embodiments of the subject disclosure. The operational flow provides a method of composing a pruned model portfolio. In at least some embodiments, the method is performed by a composing section of an apparatus including sections for performing certain operations, such as the apparatus shown in FIG. 16, which will be explained hereinafter.

At S940, the composing section or a sub-section thereof groups models. In at least some embodiments, the composing section groups pruned models among the plurality of pruned models into a plurality of groups based on memory capacity required during inference. In at least some embodiments, the composing section groups models according to predetermined memory capacity ranges. In at least some embodiments, the composing section groups models into a predetermined number of groups. In at least some embodiments, the composing section groups models according to the characteristics of the models.

At S942, the composing section or a sub-section thereof tests the accuracy of models. In at least some embodiments, the composing section tests, for a group of pruned models, the accuracy of each pruned model within the group. In at least some embodiments, as iterations of the operation at S942 proceed, the composing section tests an accuracy of each pruned model among the plurality of pruned models. In at least some embodiments, the composing section performs inference on a testing data set to test the accuracy. In at least some embodiments, the testing data set is a hold-out data set from the training data set used during training, such as in the operation at S113 of FIG. 1. In at least some embodiments, the composing section skips testing at S942 and instead use the result of an accuracy test performed on the corresponding masked model or pruned model between iterations of pruned model production, such as the pruned model production performed at S830 of FIG. 8, such as for purposes of determining whether to proceed to the next iteration of pruned model production.

At S944, the composing section or a sub-section thereof selects a model with the highest accuracy. In at least some embodiments, the composing section selects, for a group of pruned models, the pruned model having the highest accuracy of pruned models within the group. In at least some embodiments, the composing section selects a pruned model based on accuracy, but not always the pruned model having the highest accuracy, such as selecting a pruned model other than a pruned model having a highest maximum tested accuracy because that pruned model has a lower average tested accuracy.

At S945, the composing section or a sub-section thereof adds the selected model to a model portfolio. In at least some embodiments, the composing section adds the selected pruned model from a group of pruned models to a model portfolio. In at least some embodiments, as iterations of the operations at S944 and S945 proceed, the composing section adds a most accurate model among pruned models of each group among the plurality of groups to a model portfolio. In at least some embodiments, as iterations of the operations at S944 and S945 proceed, the composing section adds a single model among pruned models of each group among the plurality of groups to a model portfolio. In at least some embodiments, the composing section creates metadata for the selected pruned model, the metadata including the accuracy of the selected pruned model and the memory capacity required for inference of the selected pruned model.

At S947, the composing section determines whether all groups have been processed. In at least some embodiments, the composing section determines whether all of the model groups that were grouped at S940 have been subject to the operations at S942, S944, and S945. If the composing section determines that unprocessed groups remain, then the operational flow returns to accuracy testing at S942 to process the next group (S948). If the composing section determines whether all groups have been processed, then the operational flow ends.

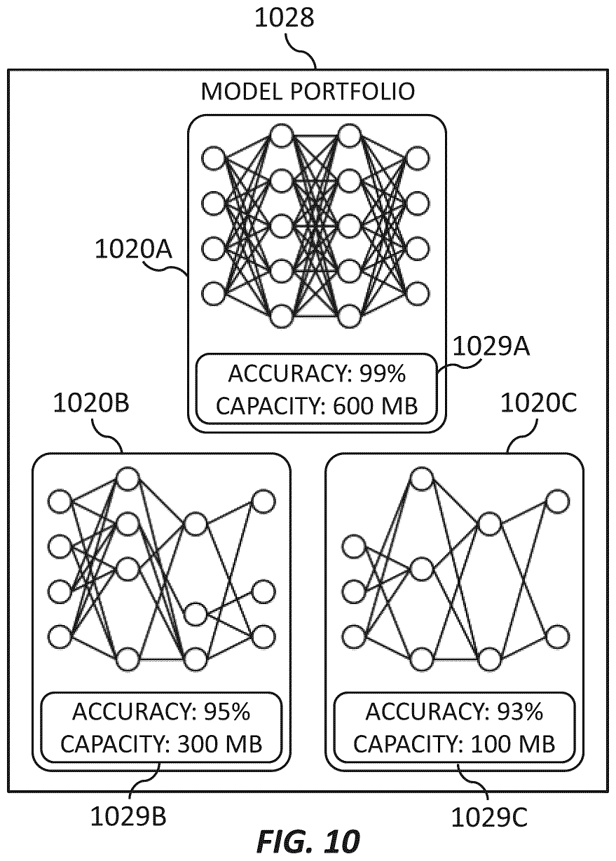

FIG. 10 is a schematic diagram of a model portfolio 1029, according to at least some embodiments of the subject disclosure. Model portfolio 1029 includes model 1020A, pruned model 1020B, and pruned model 1020C. Model portfolio further includes model metadata 1029A corresponding to model 1020A, model metadata 1029B corresponding to pruned model 1029B, and model metadata 1029C corresponding to pruned model 1029C. In at least some embodiments, each of model metadata 1029A, 1029B, and 1029C also includes an identifier of the corresponding model or pruned model. Model 1020A is the original trained model from which pruned model production began. In at least some embodiments, a model portfolio does not include the original trained model, but only includes pruned models.

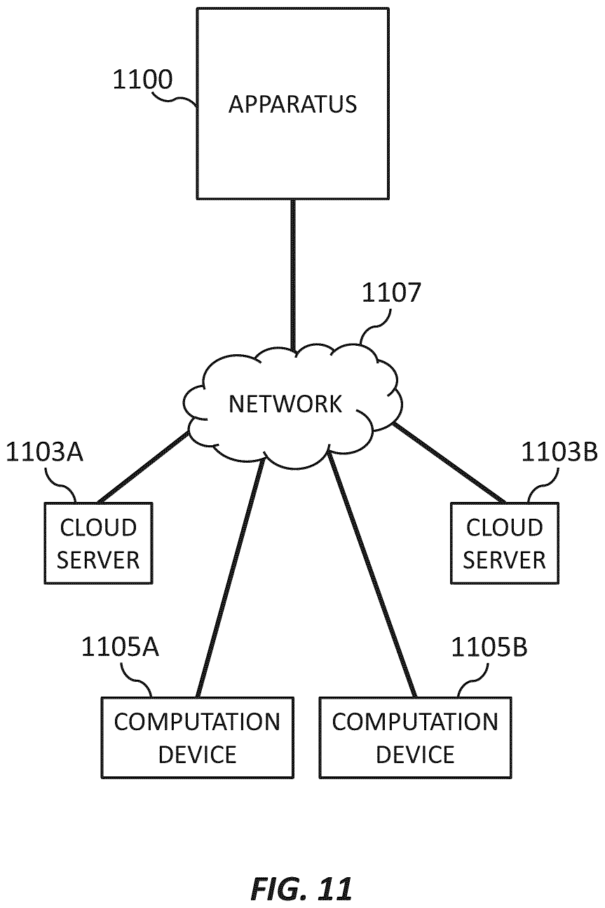

FIG. 11 is a schematic diagram of a system for generating and deploying pruned models, according to at least some embodiments of the subject disclosure. The system includes an apparatus 1100, a plurality of cloud servers 1103A and 1103B, a plurality of computation devices 1105A and 1105B, and a network 1107.

Apparatus 1100 is computation device capable of generating and deploying pruned models. In at least some embodiments, apparatus 1100 includes a non-transitory computer-readable medium including instructions executable by a processor to cause the processor to perform generation of pruned models and deployment of pruned models to cloud servers 1103A and 1103B, computation devices 1105A and 1105B, or any combination thereof. In at least some embodiments, apparatus 1100 is a computer, such as desktop computer, notebook computer, smartphone, or any other device capable of performing the operations of generating and deploying pruned models. In at least some embodiments, apparatus 1100 is a single server, a plurality of servers, a portion of a server, a virtual instance of cloud computing, etc. In at least some embodiments where apparatus 1100 is a plurality of servers or a plurality of virtual instances of cloud computing, apparatus 1100 includes a central server working with edge servers, each edge server having a logical location that is closer to the respective cloud server among cloud servers 1103A and 1103B or the respective computation device among computation devices 1105A and 1105B with which the edge server is in communication.

Cloud servers 1103A and 1103B are servers capable of performing calculations to perform neural network inference. In at least some embodiments, a portion of cloud server 1103A or 1103B is used for performing calculations to perform neural network inference as a virtual instance of cloud computing. In at least some embodiments, apparatus 1100 is configured to instruct each of cloud servers 1103A and 1103B to open multiple instances of cloud computing for neural network inference. In at least some embodiments, apparatus 1100 is configured to instruct any of cloud servers 1103A and 1103B to open a virtual instance of cloud computing with a specific memory capacity, and transmits an executable script for performing neural network inference with a model portfolio while in communication with apparatus 1100.

Computation devices 1105A and 1105B are devices capable of performing calculations to perform neural network inference. In at least some embodiments, computation devices 1105A and 1105B each include a non-transitory computer-readable medium including instructions executable by a processor to cause the processor to initiate and perform inference with a model portfolio while in communication with apparatus 1100. In at least some embodiments, computation devices 1105A and 1105B are heterogeneous, meaning the devices have varying computation resources, such as processing power, memory, etc. In at least some embodiments, computation devices 1105A and 1105B include devices having limited computation resources, such as smart watches, fitness trackers, Internet-of-Things (IoT) devices, etc., and/or devices having computation resources for a broader range of capabilities, such as smart phones, tablets, personal computers, etc.

Cloud servers 1103A and 1103B and computation devices 1105A and 1105B are in communication with apparatus 1100 through network 1107. In at least some embodiments, network 1102 is configured to relay communication among apparatus 1100 and cloud servers 1103A and 1103B and computation devices 1105A and 1105B. In at least some embodiments, network 1107 is a local area network (LAN), a wide area network (WAN), such as the internet, a radio access network (RAN), or any combination. In at least some embodiments, network 1107 is a packet-switched network operating according to IPv4, IPv6 or other network protocol.

FIG. 12 is an operational flow for deploying pruned models to a computation device, according to at least some embodiments of the subject disclosure. The operational flow provides a method of deploying pruned models to a computation device. In at least some embodiments, the method is performed by a deploying section of an apparatus including sections for performing certain operations, such as the apparatus shown in FIG. 16, which will be explained hereinafter. In at least some embodiments, the operational flow of FIG. 12 is used to deploy pruned models to other devices, including cloud servers.

At S1250, the deploying section or a sub-section thereof transmits model portfolio metadata. In at least some embodiments, the deploying section transmits a plurality of model metadata to a computation device, each model metadata among the plurality of model metadata representing the accuracy and the memory capacity required during inference of a pruned model added to the model portfolio. In at least some embodiments, the deploying section transmits model metadata of all or some of the models in a model portfolio. In at least some embodiments, the deploying section transmits model metadata, such as model metadata 1029A, 1029B, and 1029C of FIG. 10. In at least some embodiments, the deploying section transmits model metadata further including an identifier of the corresponding model.

At S1253, the deploying section or a sub-section thereof receives a request for a pruned model. In at least some embodiments, the deploying section receives a request for a pruned model among the plurality of pruned models added to the model portfolio corresponding to a selected model metadata of the request from the computation device. In at least some embodiments, the deploying section receives an identifier of the selected model.

At S1256, the deploying section or a sub-section thereof transmits a selected pruned model. In at least some embodiments, the deploying section transmits the pruned model corresponding to the selected model metadata to the computation device. In at least some embodiments, the deploying section transmits a model corresponding to an identifier received with the request at S1253.

At S1259, the deploying section or a sub-section thereof determines whether inference is complete. In at least some embodiments, the deploying section determines that inference is complete in response to receiving a signal from the computation device indicating that inference is complete. In at least some embodiments, the deploying section determines that inference is complete in response to receiving satisfactory results of the inference from the computation device. If the deploying section determines that inference is not complete, then the operational flow returns to pruned model request reception at S1253. If the deploying section determines that inference is complete, then the operational flow ends.

FIG. 13 is an operational flow for deploying pruned models to a cloud server, according to at least some embodiments of the subject disclosure. The operational flow provides a method of deploying pruned models to a cloud server. In at least some embodiments, the method is performed by a deploying section of an apparatus including sections for performing certain operations, such as the apparatus shown in FIG. 16, which will be explained hereinafter. In at least some embodiments, the operational flow of FIG. 13 is used to deploy pruned models to other devices, including computation devices.

At S1360, the deploying section or a sub-section thereof selects a model based on accuracy. In at least some embodiments, the deploying section selecting a pruned model among the plurality of pruned models added to the model portfolio corresponding to an accuracy requirement. In at least some embodiments, the deploying section refers to an accuracy requirement of a service agreement. In at least some embodiments, the deploying section selects a model among models that comply with the accuracy requirement that has the least required memory capacity for inference.

At S1364, the deploying section or a sub-section thereof transmits a selected pruned model. In at least some embodiments, the deploying section transmits the pruned model corresponding to the accuracy requirement to a cloud server. In at least some embodiments, the deploying section transmits an executable script for performing neural network inference with a model portfolio along with the selected pruned model.

At S1368, the deploying section or a sub-section thereof instructs the cloud server to perform inference. In at least some embodiments, the deploying section instructs the cloud server to perform inference of the pruned model corresponding to the accuracy requirement. In at least some embodiments, the deploying section instructs the cloud server to open a virtual instance of cloud computing with a specific memory capacity required for performing inference of the selected pruned model.

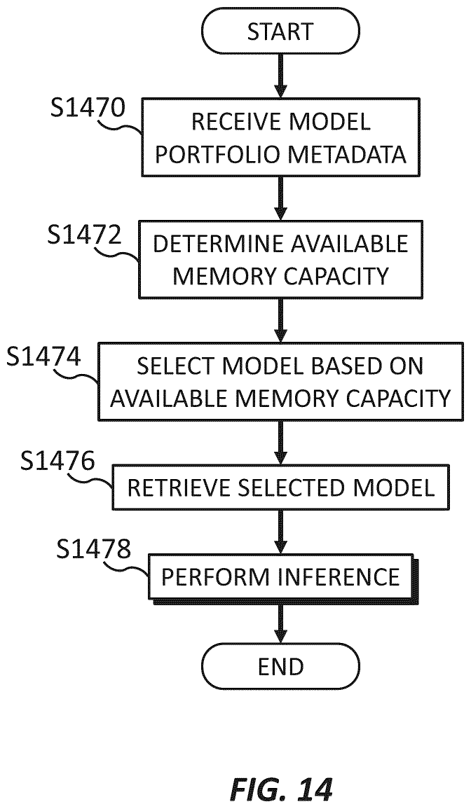

FIG. 14 is an operational flow for initiating inference with a model portfolio on a computation device, according to at least some embodiments of the subject disclosure. The operational flow provides a method of initiating inference with a model portfolio on a computation device. In at least some embodiments, the method is performed by a computation device, such as one of computation devices 1105A and 1105B of FIG. 11. In at least some embodiments, the method is performed by a cloud server, such as one of cloud servers 1103A and 1103B of FIG. 11.

At S1470, the computation device receives model portfolio metadata. In at least some embodiments, the computation device receives a plurality of model metadata from a server through a network, each model metadata among the plurality of model metadata representing an accuracy and a memory capacity required during inference of a corresponding model in a model portfolio. In at least some embodiments, the computation device receives the model metadata from an apparatus, such as apparatus 1100 of FIG. 11. In at least some embodiments, the computation device receives the model metadata from a server that is different from the apparatus.

At S1472, the computation device determines available memory capacity. In at least some embodiments, the computation device determines a memory capacity available for performing inference. In at least some embodiments, the computation device determines the instant memory capacity available. In at least some embodiments, the computation device determines a memory capacity available based on past memory usage.

At S1474, the computation device selects a model based on available memory capacity. In at least some embodiments, the computation device selects a model metadata based on the accuracy from among model metadata representing memory capacity required during inference that is less than or equal to the memory capacity available for performing inference. In at least some embodiments, the computation device selects a model that is most accurate among the models in which the computation device has sufficient memory capacity for inference.

At S1476, the computation device retrieves the selected model. In at least some embodiments, the computation device retrieves a model corresponding to the selected model metadata from the server. In at least some embodiments, the computation device downloads the model from a server that is different from the apparatus. In at least some embodiments, the computation device loads the selected model from local storage.

At S1478, the computation device performs inference. In at least some embodiments, the computation device performs inference using the model. In at least some embodiments, the computation device changes the model used for inference from the model portfolio during the performance of inference. In at least some embodiments, the computation device performs the operational flow of FIG. 14, explained hereinafter.

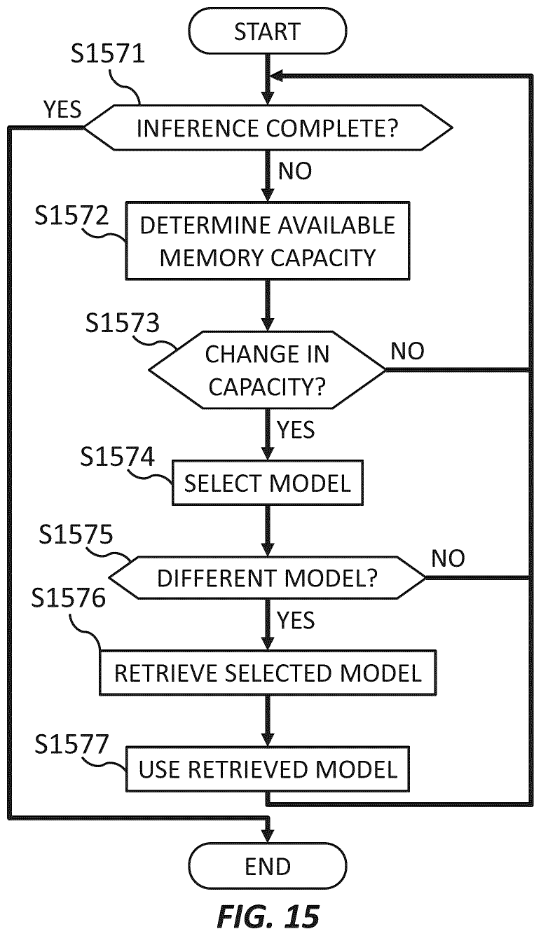

FIG. 15 is an operational flow for performing inference with a model portfolio on a computation device, according to at least some embodiments of the subject disclosure. The operational flow provides a method of performing inference with a model portfolio on a computation device. In at least some embodiments, the method is performed by a computation device, such as one of computation devices 1105A and 1105B of FIG. 11. In at least some embodiments, the method is performed by a cloud server, such as one of cloud servers 1103A and 1103B of FIG. 11.

At S1571, the computation device determines whether inference is complete. In at least some embodiments, the computation device determines that inference is complete in response to receiving a signal from an apparatus indicating that inference is complete. In at least some embodiments, the computation device determines that inference is complete in response to generating satisfactory results of the inference. If the computation determines that inference is not complete, then the operational flow proceeds to available memory capacity determination at S1572. If the deploying section determines that inference is complete, then the operational flow ends.

At S1572, the computation device determines available memory capacity. In at least some embodiments, the computation device determines, while performing inference, the memory capacity available for performing inference. In at least some embodiments, the computation device determines the instant memory capacity available. In at least some embodiments, the computation device determines a memory capacity available based on recent memory usage.

At S1573, the computation device determines whether there is a change in available memory capacity. In at least some embodiments, the computation device determines whether there is a significant change in available memory capacity. In at least some embodiments, the computation device determines whether the change in available memory capacity is greater than a difference in required memory capacity among models of the portfolio. If the computation device determines that there is not a change in available memory capacity, then the operational flow returns to completion determination at S1571. If the computation device determines that there is a change in available memory capacity, then the operational flow proceeds to model selection at S1574.

At S1574, the computation device selects a model. In at least some embodiments, the computation device selects a model metadata based on the accuracy from among model metadata representing memory capacity required during inference that is less than or equal to the memory capacity available for performing inference. In at least some embodiments, the computation device selects a model that is most accurate among the models in which the computation device has sufficient memory capacity for inference. In at least some embodiments, the computation device performs the selecting in response to a change in memory capacity available for performing inference.

At S1575, the computation device determines whether a different model was selected. In at least some embodiments, the computation device determines whether the selected model is different from the model that is currently being used for inference. If the computation device determines that the selected model is the same as the model currently being used for inference, then the operational flow returns to completion determination at S1571. If the computation device determines that the selected model is different from the model currently being used for inference, then the operational flow proceeds to model retrieval at S1576.

At S1576, the computation device retrieves the selected model. In at least some embodiments, the computation device retrieves a model corresponding to the selected model metadata from the server. In at least some embodiments, the computation device downloads the model from a server that is different from the apparatus. In at least some embodiments, the computation device loads the selected model from local storage. In at least some embodiments, the retrieving is performed in response to selecting model metadata corresponding to a different model than currently used for performing inference.

At S1577, the computation device uses the retrieved model. In at least some embodiments, the computation device stops performing inference using the previous model, and initiates inference using the retrieved model.

FIG. 16 is a block diagram of a hardware configuration for generating and deploying pruned models, according to at least some embodiments of the subject disclosure.

The exemplary hardware configuration includes apparatus 1600, which interacts with input device 1608, and communicates with cloud server 1603 and computation device 1605 through network 1607. In at least some embodiments, apparatus 1600 is a computer or other computing device that receives input or commands from input device 1608. In at least some embodiments, apparatus 1600 is integrated with input device 1608. In at least some embodiments, apparatus 1600 is a computer system that executes computer-readable instructions to perform operations for generating and deploying pruned models.

Apparatus 1600 includes a controller 1602, a storage unit 1604, an input/output interface 1606, and a communication interface 1609. In at least some embodiments, controller 1602 includes a processor or programmable circuitry executing instructions to cause the processor or programmable circuitry to perform operations according to the instructions. In at least some embodiments, controller 1602 includes analog or digital programmable circuitry, or any combination thereof. In at least some embodiments, controller 1602 includes physically separated storage or circuitry that interacts through communication. In at least some embodiments, storage unit 1604 includes a non-volatile computer-readable medium capable of storing executable and non-executable data for access by controller 1602 during execution of the instructions. Communication interface 1609 transmits and receives data from network 1607. Input/output interface 1606 connects to various input and output units, such as input device 1608, via a parallel port, a serial port, a keyboard port, a mouse port, a monitor port, and the like to accept commands and present information. In some embodiments, storage unit 1604 is external from apparatus 1600.

Controller 1602 includes masking section 1680, pruning section 1682, composing section 1684, and deploying section 1686. Storage unit 1604 includes masking parameters 1690, zero channels 1692, grouping parameters 1694, and model metadata 1696.

Masking section 1680 is the circuitry or instructions of controller 1602 configured to mask trained neural network models. In at least some embodiments, masking section 1680 is configured to produce a plurality of masked models by performing iterations of masking, initializing, and training. In at least some embodiments, masking section 1680 utilizes information in storage unit 1604, such as masking parameters 1690. In at least some embodiments, masking section 1680 includes sub-sections for performing additional functions, as described in the foregoing flow charts. In at least some embodiments, such sub-sections is referred to by a name associated with a corresponding function.

Pruning section 1682 is the circuitry or instructions of controller 1602 configured to prune masked neural network models. In at least some embodiments, pruning section 1682 is configured to perform detecting, determining, and restructuring for each masked model among the plurality of masked models, resulting in a plurality of pruned models. In at least some embodiments, pruning section 1682 records information in storage unit 1604, such as zero channels 1692. In at least some embodiments, pruning section 1682 includes sub-sections for performing additional functions, as described in the foregoing flow charts. In at least some embodiments, such sub-sections is referred to by a name associated with a corresponding function.

Composing section 1684 is the circuitry or instructions of controller 1602 configured to compose portfolios of neural network models. In at least some embodiments, composing section 1684 is configured to select pruned models that have a higher accuracy-to-size ratio from among the plurality of pruned models to include the model portfolio. In at least some embodiments, composing section 1684 utilizes information from storage unit 1604, such as grouping parameters 1694, and records information to storage unit 1604, such as model metadata 1696. In at least some embodiments, composing section 1684 includes sub-sections for performing additional functions, as described in the foregoing flow charts. In at least some embodiments, such sub-sections is referred to by a name associated with a corresponding function.

Deploying section 1686 is the circuitry or instructions of controller 1602 configured to deploy models of a model portfolio. In at least some embodiments, deploying section 1686 is configured to deploy the pruned models for performance of inference by computations devices, cloud servers, or both. In at least some embodiments, deploying section 1686 utilizes information from storage unit 1604, such as model metadata 1696. In at least some embodiments, deploying section 1686 includes sub-sections for performing additional functions, as described in the foregoing flow charts. In at least some embodiments, such sub-sections is referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiments of the subject disclosure have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Accordingly, at least some embodiments of the subject disclosure include a non-transitory computer-readable medium including instructions executable by a processor to cause the processor to perform operations comprising masking at least one edge among a plurality of edges of a trained model to produce a masked model, initializing the masked model; training the masked model; detecting, from among a plurality of channels of the masked model, each channel among the plurality of channels including a set of edges among the plurality of edges, at least one zero channel in which each edge among the set of edges is masked; determining, from among a plurality of nodes of the masked model, each node corresponding to two channels among the plurality of channels, at least one removable node in which the corresponding two channels are zero channels; and pruning the masked model to remove the removable nodes from the masked model, resulting in a pruned model. In at least some embodiments, the operations further comprise producing a plurality of masked models by performing iterations of the masking, the initializing, and the training; wherein the trained model of each subsequent iteration is the masked model after the training of a preceding iteration; and wherein the detecting, determining, and restructuring is performed for each masked model among the plurality of masked models, resulting in a plurality of pruned models. In at least some embodiments, the masking includes masking edges having a weight value less than a threshold weight value, and each subsequent iteration further comprises increasing the threshold weight value. In at least some embodiments, the operations further comprise grouping pruned models among the plurality of pruned models into a plurality of groups based on memory capacity required during inference. In at least some embodiments, the operations further comprise testing an accuracy of each pruned model among the plurality of pruned models; and adding a most accurate model among pruned models of each group among the plurality of groups to a model portfolio. In at least some embodiments, the operations further comprise transmitting a plurality of model metadata to a computation device, each model metadata among the plurality of model metadata representing the accuracy and the memory capacity required during inference of a pruned model added to the model portfolio, receiving a request for a pruned model among the plurality of pruned models added to the model portfolio corresponding to a selected model metadata of the request from the computation device, and transmitting the pruned model corresponding to the selected model metadata to the computation device. In at least some embodiments, the operations further comprise selecting a pruned model among the plurality of pruned models added to the model portfolio corresponding to an accuracy requirement; transmitting the pruned model corresponding to the accuracy requirement to a cloud server; and instructing the cloud server to perform inference of the pruned model corresponding to the accuracy requirement. In at least some embodiments, each iteration includes testing an accuracy of the masked model, and determining a decrease in accuracy between the accuracy of the masked model and a preceding accuracy of a preceding masked model of a preceding iteration; and the iterations are performed until the decrease in accuracy exceeds a threshold accuracy change value. In at least some embodiments, the initializing includes restoring initialized parameters of an untrained model previously trained to become the trained model. In at least some embodiments, the restructuring includes reformatting each layer among a plurality of layers of the masked model that includes at least one removable node.

At least some embodiments of the subject disclosure include a non-transitory computer-readable medium including instructions executable by a processor to cause the processor to perform operations comprising receiving a plurality of model metadata from a server through a network, each model metadata among the plurality of model metadata representing an accuracy and a memory capacity required during inference of a corresponding model in a model portfolio; determining a memory capacity available for performing inference; selecting a model metadata based on the accuracy from among model metadata representing memory capacity required during inference that is less than or equal to the memory capacity available for performing inference; retrieving a model corresponding to the selected model metadata from the server; and performing inference using the model. In at least some embodiments, the operations further comprise determining, while performing inference, the memory capacity available for performing inference; wherein the selecting is performed in response to a change in memory capacity available for performing inference; and wherein the retrieving is performed in response to selecting model metadata corresponding to a different model than currently used for performing inference.

At least some embodiments of the subject disclosure include a method comprising: masking at least one edge among a plurality of edges of a trained model to produce a masked model, initializing the masked model; training the masked model; detecting, from among a plurality of channels of the masked model, each channel among the plurality of channels including a set of edges among the plurality of edges, at least one zero channel in which each edge among the set of edges is masked; determining, from among a plurality of nodes of the masked model, each node corresponding to two channels among the plurality of channels, at least one removable node in which the corresponding two channels are zero channels; and pruning the masked model to remove the removable nodes from the masked model, resulting in a pruned model. In at least some embodiments, the method further comprises producing a plurality of masked models by performing iterations of the masking, the initializing, and the training; wherein the trained model of each subsequent iteration is the masked model after the training of a preceding iteration; and wherein the detecting, determining, and restructuring is performed for each masked model among the plurality of masked models, resulting in a plurality of pruned models. In at least some embodiments, the masking includes masking edges having a weight value less than a threshold weight value, and each subsequent iteration further comprises increasing the threshold weight value. In at least some embodiments, the method further comprises grouping pruned models among the plurality of pruned models into a plurality of groups based on memory capacity required during inference. In at least some embodiments, the method further comprises testing an accuracy of each pruned model among the plurality of pruned models; and adding a most accurate model among pruned models of each group among the plurality of groups to a model portfolio. In at least some embodiments, the method further comprises transmitting a plurality of model metadata to a computation device, each model metadata among the plurality of model metadata representing the accuracy and the memory capacity required during inference of a pruned model added to the model portfolio; receiving a request for a pruned model among the plurality of pruned models added to the model portfolio corresponding to a selected model metadata of the request from the computation device; and transmitting the pruned model corresponding to the selected model metadata to the computation device. In at least some embodiments, the method further comprises selecting a pruned model among the plurality of pruned models added to the model portfolio corresponding to an accuracy requirement; transmitting the pruned model corresponding to the accuracy requirement to a cloud server; and instructing the cloud server to perform inference of the pruned model corresponding to the accuracy requirement. In at least some embodiments, each iteration includes testing an accuracy of the masked model, and determining a decrease in accuracy between the accuracy of the masked model and a preceding accuracy of a preceding masked model of a preceding iteration; and the iterations are performed until the decrease in accuracy exceeds a threshold accuracy change value.

What is claimed is:

1. A non-transitory computer-readable medium including instructions executable by a processor to cause the processor to perform operations comprising:
masking at least one edge among a plurality of edges of a trained model to produce a masked model;
initializing the masked model;
training the masked model;
detecting, from among a plurality of channels of the masked model, each channel among the plurality of channels including a set of edges among the plurality of edges, at least one zero channel in which each edge among the set of edges is masked;
determining, from among a plurality of nodes of the masked model, each node corresponding to two channels among the plurality of channels, at least one removable node in which the corresponding two channels are zero channels; and
pruning the masked model to remove the removable nodes from the masked model, resulting in a pruned model.

2. The computer-readable medium of claim 1, wherein the operations further comprise
producing a plurality of masked models by performing iterations of the masking, the initializing, and the training;
wherein the trained model of each subsequent iteration is the masked model after the training of a preceding iteration; and
wherein the detecting, determining, and restructuring is performed for each masked model among the plurality of masked models, resulting in a plurality of pruned models.

3. The computer-readable medium of claim 2, wherein
the masking includes masking edges having a weight value less than a threshold weight value, and
each subsequent iteration further comprises increasing the threshold weight value.

4. The computer-readable medium of claim 2, wherein the operations further comprise
grouping pruned models among the plurality of pruned models into a plurality of groups based on memory capacity required during inference.

5. The computer-readable medium of claim 4, wherein the operations further comprise:
testing an accuracy of each pruned model among the plurality of pruned models; and
adding a most accurate model among pruned models of each group among the plurality of groups to a model portfolio.

6. The computer-readable medium of claim 5, wherein the operations further comprise:
transmitting a plurality of model metadata to a computation device, each model metadata among the plurality of model metadata representing the accuracy and the memory capacity required during inference of a pruned model added to the model portfolio;
receiving a request for a pruned model among the plurality of pruned models added to the model portfolio corresponding to a selected model metadata of the request from the computation device; and
transmitting the pruned model corresponding to the selected model metadata to the computation device.

7. The computer-readable medium of claim 5, wherein the operations further comprise:
selecting a pruned model among the plurality of pruned models added to the model portfolio corresponding to an accuracy requirement;
transmitting the pruned model corresponding to the accuracy requirement to a cloud server; and
instructing the cloud server to perform inference of the pruned model corresponding to the accuracy requirement.

8. The computer-readable medium of claim 2, wherein
each iteration includes
testing an accuracy of the masked model, and
determining a decrease in accuracy between the accuracy of the masked model and a preceding accuracy of a preceding masked model of a preceding iteration, and
the iterations are performed until the decrease in accuracy exceeds a threshold accuracy change value.

9. The computer-readable medium of claim 1, wherein the initializing includes restoring initialized parameters of an untrained model previously trained to become the trained model.

10. The computer-readable medium of claim 1, wherein the restructuring includes reformatting each layer among a plurality of layers of the masked model that includes at least one removable node.

11. A non-transitory computer-readable medium including instructions executable by a processor to cause the processor to perform operations comprising:
receiving a plurality of model metadata from a server through a network, each model metadata among the plurality of model metadata representing an accuracy and a memory capacity required during inference of a corresponding model in a model portfolio;
determining a memory capacity available for performing inference;
selecting a model metadata based on the accuracy from among model metadata representing memory capacity required during inference that is less than or equal to the memory capacity available for performing inference;
retrieving a model corresponding to the selected model metadata from the server; and
performing inference using the model.

12. The computer-readable medium of claim 11, wherein the operations further comprise
determining, while performing inference, the memory capacity available for performing inference;
wherein the selecting is performed in response to a change in memory capacity available for performing inference; and
wherein the retrieving is performed in response to selecting model metadata corresponding to a different model than currently used for performing inference.

13. A method comprising:
masking at least one edge among a plurality of edges of a trained model to produce a masked model;
initializing the masked model;
training the masked model;
detecting, from among a plurality of channels of the masked model, each channel among the plurality of channels including a set of edges among the plurality of edges, at least one zero channel in which each edge among the set of edges is masked;
determining, from among a plurality of nodes of the masked model, each node corresponding to two channels among the plurality of channels, at least one removable node in which the corresponding two channels are zero channels; and
pruning the masked model to remove the removable nodes from the masked model, resulting in a pruned model.

14. The method of claim 13, further comprising
producing a plurality of masked models by performing iterations of the masking, the initializing, and the training;
wherein the trained model of each subsequent iteration is the masked model after the training of a preceding iteration; and
wherein the detecting, determining, and restructuring is performed for each masked model among the plurality of masked models, resulting in a plurality of pruned models.

15. The method of claim 14, wherein
the masking includes masking edges having a weight value less than a threshold weight value, and
each subsequent iteration further comprises increasing the threshold weight value.

16. The method of claim 14, further comprising:
grouping pruned models among the plurality of pruned models into a plurality of groups based on memory capacity required during inference.

17. The method of claim 16, further comprising:
testing an accuracy of each pruned model among the plurality of pruned models; and
adding a most accurate model among pruned models of each group among the plurality of groups to a model portfolio.

18. The method of claim 17, further comprising:
transmitting a plurality of model metadata to a computation device, each model metadata among the plurality of model metadata representing the accuracy and the memory capacity required during inference of a pruned model added to the model portfolio;
receiving a request for a pruned model among the plurality of pruned models added to the model portfolio corresponding to a selected model metadata of the request from the computation device; and
transmitting the pruned model corresponding to the selected model metadata to the computation device.

19. The method of claim 17, further comprising:
selecting a pruned model among the plurality of pruned models added to the model portfolio corresponding to an accuracy requirement;
transmitting the pruned model corresponding to the accuracy requirement to a cloud server; and
instructing the cloud server to perform inference of the pruned model corresponding to the accuracy requirement.

20. The method of claim 14, wherein
each iteration includes
testing an accuracy of the masked model, and
determining a decrease in accuracy between the accuracy of the masked model and a preceding accuracy of a preceding masked model of a preceding iteration, and
the iterations are performed until the decrease in accuracy exceeds a threshold accuracy change value.
